(19) United States
(12) Patent Application Publication
(10) Pub. No.: US 2026/0253263 A1
(43) Pub. Date: Aug. 27, 2026

(54) BRAND-ALIGNED IMAGE GENERATION USING DIRECT PREFERENCE OPTIMIZATION

(71) Applicant: Adobe Inc., San Jose, CA (US)

(72) Inventors: Ambareesh REVANUR, San Jose, CA (US); Shradha AGRAWAL, Milpitas, CA (US); Dhwanit AGARWAL, San Jose, CA (US)

(21) Appl. No.: 19/064,223

(22) Filed: Feb. 26, 2025

(51) Int. Cl. G06T 11/00; G06V 10/82; G06V 20/70

(52) U.S. Cl. CPC G06T 11/00; G06V 10/82; G06V 20/70

(57) ABSTRACT

Some aspects relate to technologies providing a framework for training a brand-aligned image generation model to generate brand-aligned images. In accordance with some aspects, the brand-aligned image generation model is trained by first receiving a brand-aligned image and generating a caption describing the brand-aligned image. A non-brand-aligned image is generated from the caption using a generic image generation model. The brand-aligned image and the non-brand-aligned image form an image pair that is used to train the brand-aligned image generation model.

### BACKGROUND

Digital marketing frequently requires generating images for a particular brand. One increasingly used technique leverages generative artificial intelligence (AI) models to create brand-aligned content for digital marketing campaigns. This use of generative AI poses various challenges, including training AI models to understand the aspects of the brand, adequately describing the brand aspects using text prompts to the AI models, and generating images with proper interaction between brand elements. One particular challenge is that there can be a scarcity of training data for a particular brand resulting in an AI model that cannot generate images that correctly represent a complex brand identity. Together, these challenges typically result in AI-generated content that is of poor quality or that does not reflect brand identity.

### SUMMARY

Some aspects of the present technology relate to, among other things, using image generation models to generate brand-aligned images. In accordance with some aspects of the technology described herein, users can use a brand-aligned image generation system to generate brand-aligned images (e.g., images that conform to style and substance of a particular brand). As described herein, a user provides a set of brand-aligned images and, for each of those images, a caption is generated for the image using a language model such as a large language model (LLM). The caption generated can be a simple caption that describes the image, as described below, or can be a dense caption that incorporates additional style information from, for example, a brand guidelines document. In some embodiments, the brand-aligned image generation uses LLMs to generate both a simple caption and a dense caption for each brand image, as described below.

The brand-aligned image generation system then uses an image generation model to generate images based on the captions. In some aspects, the brand-aligned image generation system can use an image generation model to generate a single image for each caption. In some aspects, the brand-aligned image generation system can use an image generation model to generate a plurality of images for each caption. For example, for a given brand image, the brand-aligned image generation system can generate a simple caption and a dense caption and then can use an image generation model to generate five images for each of those captions. These generated images are then used to generate positive and negative image pairs (e.g., one pair for each image generated from the captions) so that, in the example above, ten image pairs are generated where, in each pair, the positive image is the original brand-aligned image and the negative image is the generated image (e.g., generated from the caption). The image pairs are used to train a brand-aligned image generation model that can be used to generate brand-aligned images from text prompts.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system for generating brand-aligned images, in accordance with implementations of the present disclosure;

FIG. 2 is a block diagram illustrating data flow of the brand-aligned image generation system, in accordance with some implementations of the present disclosure;

FIG. 3 is a block diagram illustrating loss functions of the brand-aligned image generation system, in accordance with some implementations of the present disclosure;

FIG. 4 is a block diagram illustrating low-rank adaptation modules to train the brand-aligned image generation model of the brand-aligned image generation system, in accordance with some implementations of the present disclosure;

FIG. 5 is a flow diagram showing an example process for training the brand-aligned image generation model of the brand-aligned image generation system, in accordance with some implementations of the present disclosure;

FIG. 6 is a flow diagram showing an example process for training the brand-aligned image generation model of the brand-aligned image generation system, in accordance with some implementations of the present disclosure;

FIG. 7 shows an example of a guided diffusion model according to aspects of the present disclosure;

FIG. 8 shows an example of a U-Net according to aspects of the present disclosure;

FIG. 9 shows an example of a method for conditional media generation according to aspects of the present disclosure;

FIG. 10 shows a diffusion process according to aspects of the present disclosure;

FIG. 11 shows a flow diagram depicting an algorithm as a step-by-step procedure for training a machine learning model according to aspects of the present disclosure;

FIG. 12 shows an example of a method for training a diffusion model according to aspects of the present disclosure;

FIG. 13 shows an example of a computing device according to aspects of the present disclosure; and

FIG. 14 shows an example of a brand-aligned image generation apparatus according to aspects of the present disclosure.

### DETAILED DESCRIPTION

### Definitions

Various terms are used throughout this description. Definitions of some terms are included below to provide a clearer understanding of the ideas disclosed herein.

As used herein, an “image” is a visual image comprising either a single frame or a plurality of frames (e.g., a video). As used herein, “image” is a term encompassing images, videos, animations, etc.

As used herein, a “brand-aligned image” is an image that displays a brand identity including colors, logos, styles, etc., of an image. In some instances, a brand-aligned image is provided by a user. In some instances, a brand-aligned image is generated by a brand-aligned image generation model that is trained using systems and methods described herein.

As used herein, a “non-brand-aligned image” is an image that does not necessarily display brand identity elements. In some instances, a non-brand-aligned image is generated from a caption of a brand-aligned image, as described herein. In some instances, a non-brand-aligned image is selected from a set of images used to, for example, train a generic (not fine-tuned) image generation model. Unless otherwise stated or made clear from context, a non-brand-aligned image should be construed to be an image generated from a brand-aligned image and a set of non-brand-aligned images (described below) should be construed to mean images selected from a set of images used to train a generic image generation model.

As used herein, an “image caption” is a caption of an image, automatically generated by a language model using systems and methods described herein.

As used herein, a “simple caption” is an image caption that does not include additional content or context. As used herein, a simple caption plainly describes the image without adding additional nuance.

As used herein, a “dense caption” is an image caption that does include additional content or context. As used herein, a dense caption includes brand identity information such as colors, logos, shapes, relationships, style, etc. In some instances, a dense caption includes dynamic context (e.g., context that is generated at run-time by a language model or by an image generation model).

As used herein, “brand guidelines” are guidelines that establish a brand identity. As described above, brand guidelines can include brand identity information such as colors, logos, shapes, relationships, style, etc. Brand guidelines are typically presented in a brand concept document, described below. Herein, “brand guidelines” and “brand identity” (described below) are used interchangeably.

As used herein, “brand identity” includes descriptions of elements that identify a brand and can include colors, logos, shapes, relationships, style, etc.

As used herein, a “brand concept” comprises brand guidelines. Typically, a brand concept is presented as a brand concept document that is provided by a user to help guide generation of brand-aligned content.

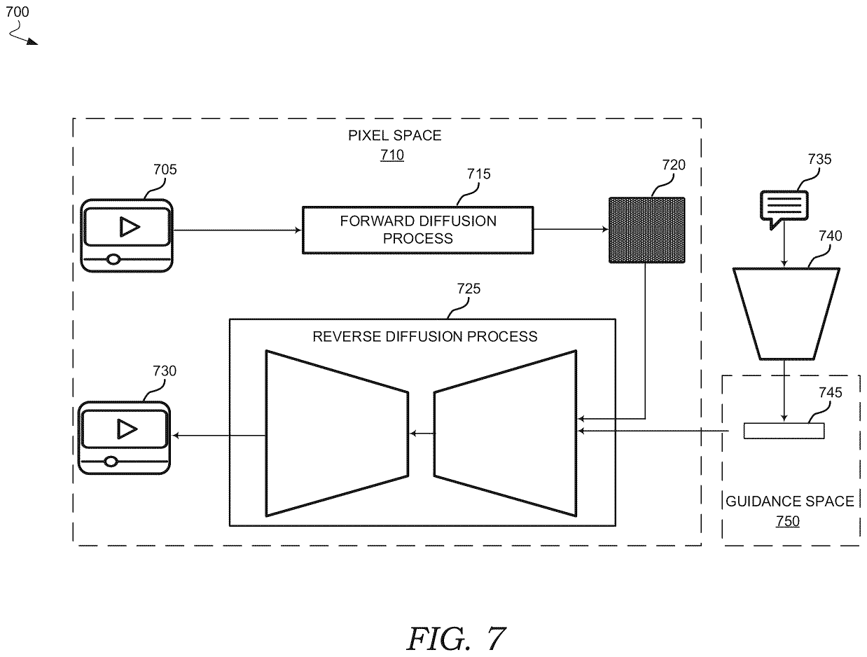

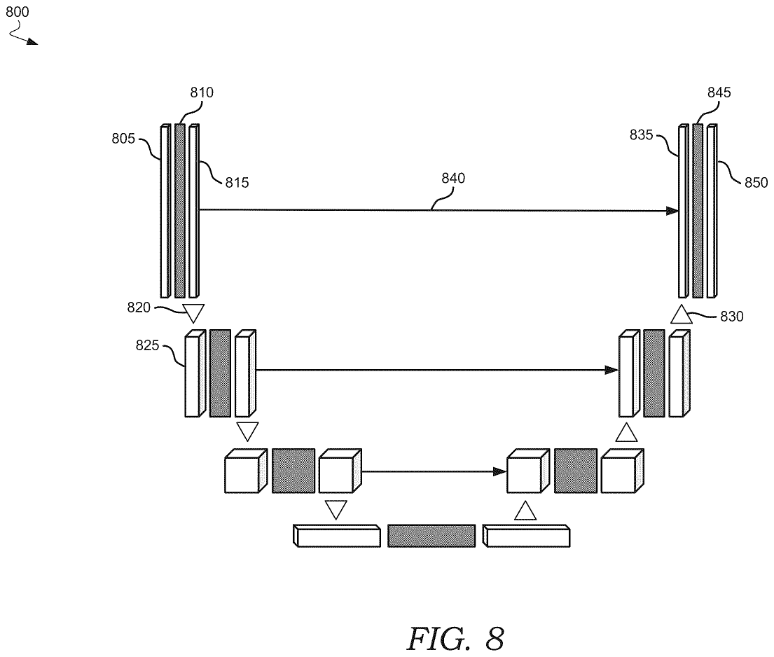

As used herein, an “image generation model” is an artificial intelligence (AI) model that generates images from image generation prompts. An image generation model is typically a guided diffusion model that is implemented as a U-Net, as described herein in connection with FIGS. 7 and 8.

As used herein, a “generic image generation model” is an image generation model that is not fine-tuned. A generic image generation model may also be referred to as an off-the-shelf image generation model or a general image generation model.

As used herein, a “brand-aligned image generation model” is an image generation model that is based on a generic image generation model but that has been trained (e.g., fine-tuned) to generate brand-aligned images. A brand-aligned image generation model is trained using systems and methods described herein.

As used herein, “model collapse” occurs when a machine learning model degrades due to errors that come from uncurated training based on the outputs of another model (including prior versions of itself). Such outputs are known as synthetic data. Model collapse generally occurs due to approximation errors, sampling errors, and learning errors.

As used herein, a “positive image” is an image of an image training pair that indicates the type of image that a trained image generation model should generate.

As used herein, a “negative image” is an image of an image training pair that indicates the type of image that a trained image generation model should not generate. It should be noted that a negative image should be a high-quality negative image (e.g., close to the positive image, but different enough so that the differences are enough to train an image generation model to prefer the positive image over the negative image).

As used herein, an “image pair” includes a positive image and a negative image. It should be noted that a negative image should be a high-quality negative image (e.g., close to the positive image, but different enough so that the differences are enough to train an image generation model to prefer the positive image over the negative image). A negative image that is radically different from the corresponding positive image has too many differences to effectively train an image generation model. Conversely, a negative image that is too close to the corresponding positive image has too few differences to effectively train an image generation model.

As used herein, a set of “non-brand-aligned images” is a set of images that are selected to aid in training the brand-aligned image generation model so that the trained brand-aligned image generation model can generate both brand-aligned and non-brand-aligned content. In some instances, the set of non-brand-aligned images is selected from the model images (e.g., images used to train a generic image generation model. In some instances, the set of non-brand-aligned images is manually selected. In some instances, the set of non-brand-aligned images is automatically selected. As used herein, unless otherwise stated or made clear from context, a “set of non-brand-aligned images” refers to the set of images used to enhance the training of the brand-aligned image generation model, whereas a “non-brand-aligned image” is an image generated from a brand-aligned image using systems and methods described herein.

As used herein, a “low-rank adaptation (LoRA)” is an image model training technique that uses LoRA modules to manage a relatively small number of training parameters to fine-tune an image generation model. In some instances, LoRA modules manage the on-loading and off-loading of the training parameters, enabling efficient storage of the training parameters.

As used herein, a “brand-aware loss function” is a loss function of an image generation model that combines diffusion-DPO loss (e.g., based on image pairs, described below) with noise-reconstruction loss (e.g., based on a set of non-brand images).

As used herein, “DPO” is direct preference optimization, a technique used in image generation models.

As used herein, “diffusion-DPO loss” is a loss term that uses a direct preference optimization term that is based on the pairwise data (e.g., the positive and negative image pairs). Diffusion-DPO loss trains an image generation model to be aware of, which in this instance, is brand-aligned content.

As used herein, “noise reconstruction loss” is a loss term that causes a diffusion network (e.g., an image model) to retain the noise latent knowledge from a base model. Noise reconstruction loss is based on the set of non-brand-aligned images. Noise reconstruction loss trains an image generation model to be aware of non-brand-aligned content.

As used herein, a “prompt” to an image generation model or a language model is a natural language request for a response from the respective language models. In some instances, a prompt to a language model is to generate a caption (e.g., a dense caption or a simple caption) for an image. In some instances, a prompt to an image generation model is to generate an image based on a description (e.g., the caption).

### Overview

Generating brand-aligned images using modern artificial intelligence-based (AI-based) image generation techniques is challenging for many reasons. An AI-based image generation model, such as those described herein, typically cannot fully capture brand-related concepts, which can include colors and logos, but can also include style guidelines and other brand-content guidelines. This is because AI-based image generation models are trained on a large corpus of images, sometimes several million or more, and virtually none of those images are brand-aligned. For example, the chance that a prompt to a generic image generation model (e.g., one that is not fine-tuned) to “generate a picture of a person using a leaf blower to clear a yard covered in fallen leaves” would cause the model to generate brand-specific content (e.g., using a leaf blower of the specific brand) is essentially zero.

Additionally, since image generation models rely on text prompts (e.g., “generate a picture of a person using a leaf blower to clear a yard covered in fallen leaves”), it can be difficult to compactly represent the brand-aligned elements of an image in these text prompts. For example, while it is possible to express some brand-aligned elements in text (e.g., “using a leaf blower of some particular brand that is a particular shade of red,” ““using a leaf blower that is this shade of green,” “using a leaf blower with this logo,” etc.), others are not easily describable in words. Brand visual identity typically comprises many elements that are difficult to articulate clearly, including nuances in imagery style, typography, logos, and other such abstract qualities. In this case, a prompt to generate a brand-aligned image based on a simple prompt to “generate a picture of a person using a leaf blower to clear a yard covered in fallen leaves” could require a prompt of dozens, if not hundreds, of sentences. Furthermore, brand identity can also include complex interactions between various visual elements so that, for example, the leaf blower must be used outside and in a yard, and the leaves must have come from a tree, and the tree must be within a fence, and so on. These interactions are also difficult to express in effective text prompts.

One approach to address these shortcomings is to fine-tune an AI-based image generation model so that it is familiar with, and can generate, brand-aligned content. An AI-based image generation model is trained with images (e.g., brand-aligned images), so that it “understands” the nuances of the brand-aligned content. However, this fine-tuning presents a number of additional problems. For example, many brands only have a relatively small corpus of brand-aligned content and images to use for training AI-based models. As mentioned above, a typical AI-based image generation model can be trained using millions of source images. By contrast, a brand might have only a few dozen images to use for training. This comparatively small corpus of training images can cause numerous problems. First, the small corpus of brand-aligned images makes it difficult for the AI-based image generation model to fully capture a brand's visual identity. Second, this small corpus of brand-aligned images can cause model collapse, where the fine-tuned model over-emphasizes the visual elements from the brand-aligned images. So, when the model is trained using a brand-aligned image corpus that includes a number of image elements of, for example, a particular shade of green, the model may tend to use that color for everything. Third, the corpus of brand-aligned images may cause the image generation model to incorrectly generate images that are brand-aligned when they should not be. Having a fine-tuned model that only generates brand-aligned content reduces the utility of the model. Finally, as mentioned above, this small corpus of brand-aligned images typically will not capture all of the nuances of the visual identity of a brand.

These factors can cause an AI-based image generation model to generate poor quality images, do not conform to the brand identity, or are simply incorrect. This can cause considerable regeneration of brand-aligned images, frequently requiring a user to generate an image, adjust the prompt, regenerate the image, and so on. This results in considerable additional use of computing system processing and extraordinary delays in generating the brand-aligned content for a particular brand.

Aspects of the technology described herein generate brand-aligned images using AI-based image generation where those images are based on a comparatively small corpus of brand-aligned images, while retaining the efficiency of image generation based on the large corpus of non-brand-aligned images. The generated brand-aligned images maintain both the overt elements of the brand while incorporating the subtle nuances of the brand identity. The brand-aligned image generation system described herein addresses the challenges of limited brand-specific data while generating quality images that retain the complexity of brand identities.

A first aspect of how the brand-aligned image generation system addresses the challenge of limited brand-specific data while generating quality images that retain the complexity of brand identities is in how training data that is used to train the image generation model is generated. As described above, a user provides a set of brand-aligned images and, for each of those images, a caption is generated for the image using a language model such as a large language model (LLM). The caption generated can be a simple caption that describes the image content, a dense caption that incorporates additional style information from a brand guidelines document, or both of these captions (e.g., one of each type). The brand-aligned image generation system then uses an image generation model, such as those described herein to generate images based on the generated captions. The brand-aligned image generation system uses an image generation model to generate one or more images for each generated caption. For example, for a given brand image, the brand-aligned image generation system generates a simple caption and a dense caption and then uses an image generation model to generate, for example, five images for each of those captions. These generated images are then used to generate positive and negative image pairs (e.g., one pair for each image generated from the captions) so that, in the example above, ten image pairs are generated where the positive image is the original brand-aligned image and the negative image is the generated image (e.g., generated from the caption). These negative images are used, in combination with the positive image, to train the brand-aligned image generation model as each image pair indicates what the brand-aligned image model should generate (e.g., the positive image) and also what the brand-aligned image model should not generate (e.g., the negative image).

A second aspect of how the brand-aligned image generation system addresses the challenge of limited brand-specific data while generating quality images that retain the complexity of brand identities is in the training mechanism (e.g., how the training data is used). The brand-aligned image generation model is trained using a direct preference optimization (DPO) technique that combines both the standard DPO loss function with a prior knowledge preservation loss function. The combination of these two loss functions prevents overfitting of the image generation model and prevents model collapse, as described herein. The prior knowledge preservation loss function, described herein, is based on a further set of non-brand images (e.g., images that do not include any brand-aligned or even brand-related content). This enables the trained brand-aligned image generation system to generate both brand-aligned and non-brand-aligned content, as described herein.

A third aspect of how the brand-aligned image generation system addresses the challenge of limited brand-specific data while generating quality images that retain the complexity of brand identities is in how the training uses low-rank adaptation (LoRA) to efficiently train two models (e.g., the brand-aligned model and the non-brand-aligned model). Because the models are trained using a combination of a DPO loss function and a prior knowledge preservation loss function, LoRA allows the training to maintain both models in memory with a reduced computational costs. As described herein, at each layer of model training, the layer weights for the brand-aligned model (e.g., using the DPO loss function) are combined with the layer weights for the non-brand-aligned model (e.g., using the prior knowledge preservation loss function). Using LoRA, the layer weights can be efficiently loaded into memory (on-loaded) and also loaded out of memory (off-loaded) so that the computational complexity of the additional model is reduced considerably. For example, if a particular layer in base model weights are a 10×10 matrix (e.g., with a hundred parameters) the weights for the prior knowledge preservation loss function can be stored, using LoRA, as a l0×1 matrix and a 1×10 matrix which, when multiplied, yield a 10×10 matrix from only twenty parameters. Further details of the LoRA implementation are described below.

Aspects of the technology described herein provide a number of improvements over existing technologies. For example, the generation of the training data from a limited brand-aligned dataset using both simple and dense captions, combined with the combination of the DPO loss with the prior knowledge preservation loss enables the brand-aligned image generation system to adapt to diverse brand identities, using the power of existing image generation systems (e.g., not fine-tuned) while integrating brand-specific rules and guidelines. This enables the brand-aligned image generation system to generate content that adheres to brand identity without requiring extensive prompt engineering (e.g., the generation of highly detailed and complex prompts). This reduces interaction with the system due to iterative prompt engineering and reduces the use of computational resources. Additionally, the use of LoRA modules in training significantly reduces both the memory requirements and computational requirements for training the brand-aligned image generation system, optimizing both and improving the computational systems used to perform the training.

### Example Systems and Methods for Generating Brand-Aligned Images

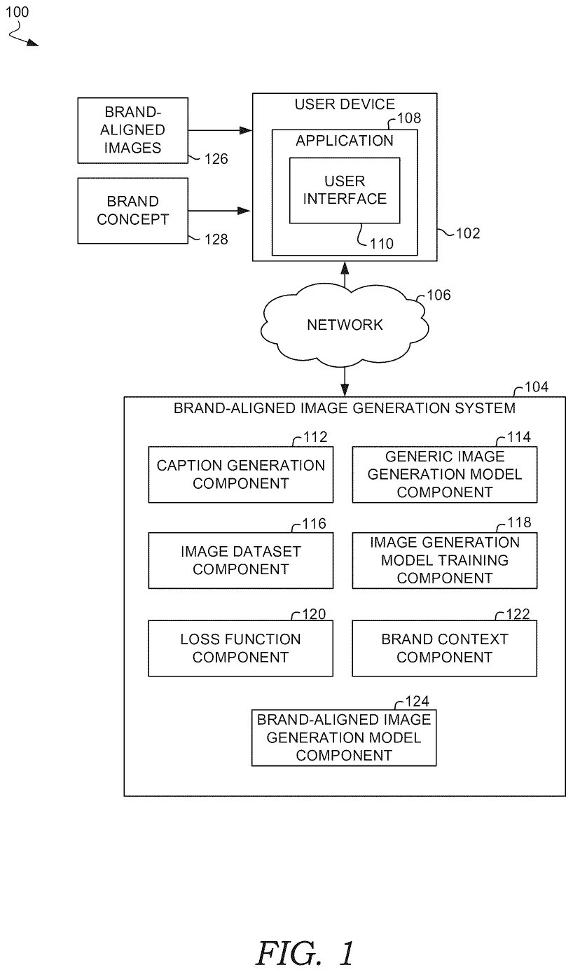

With reference now to the drawings, FIG. 1 is a block diagram illustrating an exemplary system 100 for generating brand-aligned images, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

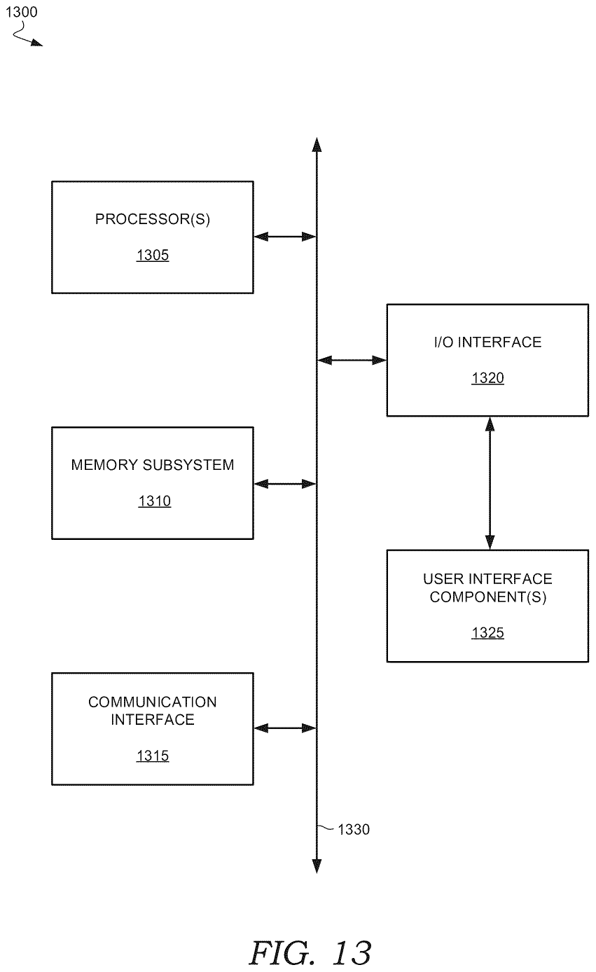

The system illustrated in block diagram 100 is an example of a suitable architecture for implementing certain aspects of the present disclosure. Among other components not shown, the system illustrated in block diagram 100 includes a user device 102 and a brand-aligned image generation system 104. Each of the user device 102 and the brand-aligned image generation system 104 shown in FIG. 1 can comprise one or more computer devices, such as the computing device 1300 of FIG. 13, described below. As shown in FIG. 1, the user device 102 and the brand-aligned image generation system 104 communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the brand-aligned image generation system 104 may be provided by multiple server devices collectively providing the functionality of the brand-aligned image generation system 104, as described herein. Additionally, other components not shown may also be included within the environment.

The user device 102 is a client device on the client-side of the operating environment illustrated in block diagram 100, while the brand-aligned image generation system 104 is on the server-side of the operating environment illustrated in block diagram 100. The brand-aligned image generation system 104 can comprise server-side software designed to work in conjunction with client-side software on the user device 102 so as to implement any combination of the features and functionalities discussed in the present disclosure. For example, the user device 102 can include an application 108 for interacting with the brand-aligned image generation system 104. The application 108 is, for instance, a web browser or a dedicated application for providing functions, such as those described herein. This division of an operating environment illustrated in block diagram 100 is provided to illustrate one example of a suitable environment. There is no requirement for each implementation that any combination of the user device 102 and the brand-aligned image generation system 104 remain as separate entities. While the operating environment illustrated in block diagram 100 illustrates a configuration in a networked environment with a separate user device 102 and brand-aligned image generation system 104, it should be understood that other configurations are employed in which aspects of the various components are combined. For instance, in some aspects, aspects of the brand-aligned image generation system 104 are implemented in part or in whole by the user device 102.

In some configurations, the application 108 can comprise a user interface 110. In some configurations, the user interface 110 provides one or more user interfaces to a user of a device, such as the user device 102, for interacting with the brand-aligned image generation system 104. In some instances, the user interface 110 is presented on the user device 102 via the application 108, which is a web browser or a dedicated application for interacting with the brand-aligned image generation system 104. For instance, the user interface 110 can provide user interfaces for, among other things, receiving input from a user and providing responses to the user. It should be noted that, while the user interface 110 is shown as an element of application 108, in some embodiments, the brand-aligned image generation system 104 further includes a user interface component (not shown in FIG. 1) that provides one or more user interfaces for interacting with the brand-aligned image generation system 104. In some aspects, not shown in FIG. 1, a user interface component provides one or more user interfaces to a user device, such as the user device 102 via the application 108.

The user device 102 can comprise any type of computing device capable of use by a user. For example, in one aspect, a user device is of the type of computing device 1300 described in relation to FIG. 13 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the brand-aligned image generation system 104 via the user device 102.

In some configurations, the brand-aligned image generation system 104 is implemented, at least in part, using artificial intelligence models that generate responses to user queries through natural language interaction. In such instances, the brand-aligned image generation system 104 can use artificial intelligence and machine learning (ML) algorithms to understand user queries, interpret context, and generate responses by accessing relevant information from various sources. In at least one embodiment, the brand-aligned image generation system 104 uses generative models such as those described herein to understand user queries, interpret context, and generate and optimize web forms using systems, methods, operations, and techniques such as those described herein.

In some aspects, the brand-aligned image generation system 104 receives a set of brand-aligned images 126 and a brand concept 128 (e.g., a brand concept document), generates one or more captions for the brand-aligned image, and uses an untrained image generation model to generate images for each of the captions. These images generated by the untrained image generation model form a set of negative images (e.g., images that are expressly not brand-aligned), and each of the set of negative images is combined with the brand-aligned image to form an image pair. The positive image (e.g., the brand-aligned image) and the negative image (e.g., the non-brand-aligned image) are then used to train the brand-aligned image generation model. In some aspects, during training, LoRA modules are used to facilitate efficient on-loading and off-loading of layer parameters used to train the brand-aligned image generation model.

In some aspects, the brand-aligned image generation system 104 receives the set of positive and negative images, as described above, and also receives an additional set of non-brand-aligned images that are taken from a stock set of training images (e.g., used to train the untrained image generation model). This set of non-brand-aligned images can be automatically selected or can be manually selected. These two sets of images are used to generate a DPO loss function and a prior knowledge preservation loss function and the two loss functions are used to train the brand-aligned image generation model. In some aspects, during training, LoRA modules are used to facilitate efficient on-loading and off-loading of layer parameters used to train the brand-aligned image generation model.

As shown in FIG. 1, the brand-aligned image generation system 104 comprises a caption generation component 112, a generic image generation model component 114, an image dataset component 116, an image generation model training component 118, a loss function component 120, a brand context component 122, and/or a brand-aligned image generation model component 124. The components of the brand-aligned image generation system 104 are in addition to other components that provide further additional functions beyond the features described herein. The brand-aligned image generation system 104 is implemented using one or more server devices, one or more platforms with corresponding application programming interfaces, cloud infrastructure, and the like. While the brand-aligned image generation system 104 is shown as separate from the user device 102 in the configuration of FIG. 1, it should be understood that in other configurations, some or all of the functions of the brand-aligned image generation system 104 are provided on the user device 102. Additionally, in some configurations, one or more of the components of the brand-aligned image generation system 104 shown in FIG. 1 (e.g., the caption generation component 112, the generic image generation model component 114, the image dataset component 116, the image generation model training component 118, the loss function component 120, the brand context component 122, and/or the brand-aligned image generation model component 124) are provided by the user device 102 and/or another device not shown in FIG. 1. In some configurations, the components of the brand-aligned image generation system 104 are provided by a single entity or by multiple entities.

In some aspects, the functions performed by the components of the brand-aligned image generation system 104 are associated with one or more applications, services, or routines. In particular, such applications, services, or routines may operate on one or more user devices and servers, may be distributed across one or more user devices and servers, or may be implemented in the cloud. Moreover, in some aspects, these components of the brand-aligned image generation system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein is performed, at least in part, by one or more hardware logic components. For example, and without limitation, illustrative types of hardware logic components that are used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in the example system illustrated in block diagram 100, it is contemplated that in some aspects, functionality of these components is shared or distributed across other components.

Given an input from a user device (e.g., user device 102) to generate brand-aligned images, the brand-aligned image generation system 104 uses the caption generation component 112 to generate captions for the brand-aligned images 126. The caption generation component 112 can use a large-language model (LLM) such as those described herein to generate the captions of the brand-aligned images 126. As described herein, the caption generation component 112 generates both simple captions (e.g., a simple description of each of the brand-aligned images 126) as well as dense captions (e.g., a more complex description that incorporates brand-aligned elements into the dense caption). Typically, the caption generation component 112 incorporates elements from the brand concept 128 to generate the dense caption. The caption generation component uses the brand context component 122 to analyze the brand concept 128 and generate the dense caption. As an example, consider a brand-aligned image of brand-aligned images 126 that shows a person hanging a tool on a wall-mounted rack in a well-lit room. A prompt to the caption generation component 112 to generate a simple caption might be “describe the image briefly,” and the resulting simple caption might be “a person is hanging a tool on a wall-mounted rack in a well lit room.” A prompt to generate the caption generation component 112 to generate a dense caption might be “describe the image in terms of the brand concept document,” and the resulting dense caption might be “A person is hanging a tool on a wall-mounted rack in a well lit room. Use warm tones. The tool is green. Use a garage environment. Use ambient and direct lighting. Focus on the person.” As described herein, the caption generation component 112 is used by, or in conjunction with, a number of other components of the brand-aligned image generation system 104 to train a brand-aligned image generation model.

Given captions from the caption generation component 112, the brand-aligned image generation system 104 uses the generic image generation model component 114 to generate non-brand-aligned images based on those captions. The generic image generation model component 114 uses a generic image generation model (e.g., not fine-tuned) such as those described herein to generate the non-brand-aligned images. As described herein, the generic image generation model component 114 can generate a plurality of images from the simple caption and can also generate a plurality of images from the dense caption. The plurality of images generated by the generic image model generation component 114 are designed to make high-quality generated images. This is because the generated images are used as negative images, as described herein, and a better quality negative image provides more effective training for the brand-aligned image generation model. The negative image (e.g., the image generated by the generic image generation model component 114) is an image that the generic model would normally generate, but that the brand-aligned image generation model should not generate. Thus, the higher quality the negative image is, the better the brand-aligned image generation model can learn. As described herein, the generic image generation model component 114 is used by, or in conjunction with, a number of other components of the brand-aligned image generation system 104 to train a brand-aligned image generation model.

Given the generic images from the generic image generation model component 114 (e.g., the negative images), the brand-aligned image generation system 104 uses the image dataset component 116 to create training image pairs where each image pair includes the source brand-aligned image and a generic image from the generic image generation model component 114. For example, if the caption generation component 112 generates two captions for a brand-aligned image (e.g., a simple caption and a dense caption), and the generic image generation model component 114 generates five negative images for each caption, the image dataset component 116 would generate ten image pairs for each brand-aligned image of brand-aligned images 126. As described herein, the image dataset component 116 is used by, or in conjunction with, a number of other components of the brand-aligned image generation system 104 to train a brand-aligned image generation model.

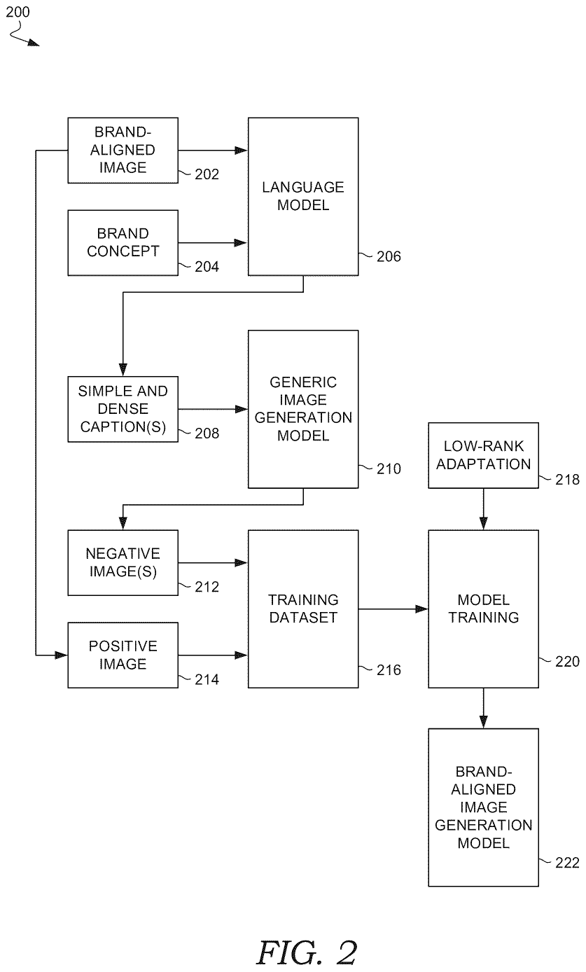

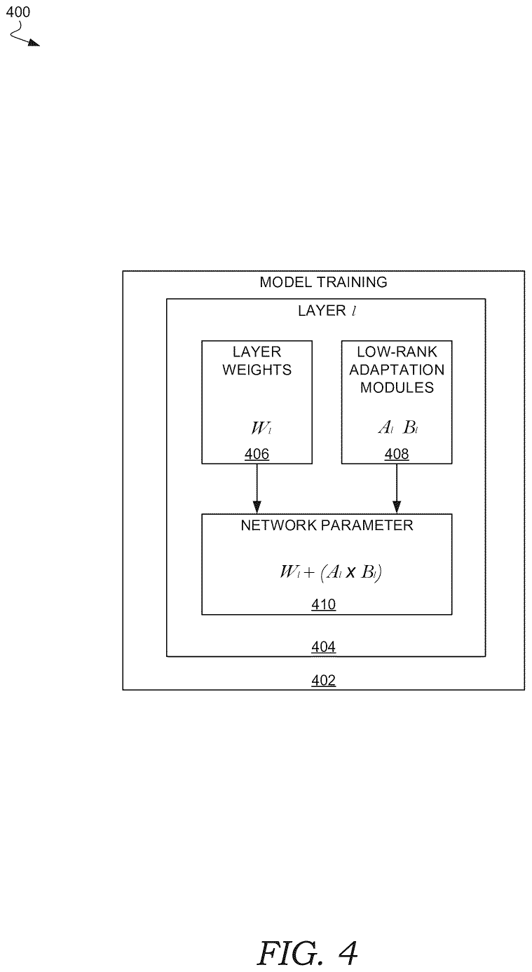

Given training pairs generated by the image dataset component 116, the brand-aligned image generation system 104 uses the image generation model training component 118 to train the brand-aligned image generation model. The image generation model training component 118 is trained using the loss function component 120, which uses a DPO loss function and a prior knowledge loss function, as described herein, to train the brand-aligned image generation model. The image generation model training component 118 is also trained using one or more low rank adaptation (LoRA) modules, as described in connection with FIGS. 2 and 4. As described herein, the image generation model training component 118 is used by, or in conjunction with, a number of other components of the brand-aligned image generation system 104 to train a brand-aligned image generation model. The trained brand-aligned image generation model as well as the generic image generation model of the generic image generation model component 114 are then used by the brand-aligned image generation model component 124 to generate brand-aligned image content, using systems and methods described herein.

Turning now to FIG. 2, FIG. 2 is a block diagram 200 illustrating data flow of the brand-aligned image generation system 104, in accordance with some implementations of the present disclosure. The example data flow illustrated in FIG. 2 is for a single brand-aligned image 202, which is typically one of a plurality of brand-aligned images such as those described in FIG. 1. A brand-aligned image 202 is provided to a language model 206 (e.g., an LLM), which generates a caption for the image. The caption can be a simple caption, based on the image, or can be a dense caption, informed by information contained in the brand concept 204, which is a description of the brand elements and/or the brand identity, as described herein. The language model 206 generates one or more simple and/or dense captions 208 for the brand-aligned image 202. The simple and/or dense captions 208 each comprise a description of the brand-aligned image 202 that does not depict overt elements of the brand identity (e.g., specific colors, logos, etc.), but the dense captions may include intrinsic elements of the brand identity (e.g., arrangements, color tones, etc.).

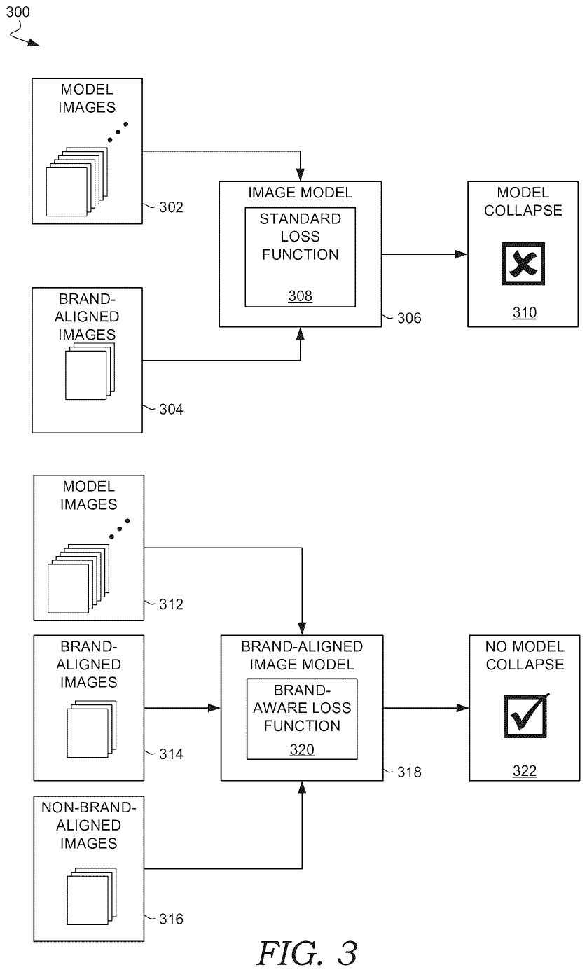

The simple and/or dense captions 208 are provided to a generic image generation model 210 that is not fine-tuned. This generic image generation model 210 is also referred to as an “off-the-shelf” image generation model such as DALL-E, Midjourney, Adobe® Firefly, etc. Based on the simple and/or dense captions 208, the generic image generation model 210 generates negative images 212, which are a set of images generated by the generic image generation model 210 based on the descriptions (e.g., the captions) obtained from the language model 206. The generic image generation model 210 typically generates a plurality of negative images 212 for each of the captions (e.g., five images for each of the simple and dense captions). Each of these negative images 212 is paired with a single positive image 214 (e.g., the brand-aligned image 202) to generate positive and negative image pairs. Together, these positive and negative image pairs comprise a training dataset 216 that is used for model training 220. As a result of model training 220, a brand-aligned image generation model 222 is trained. The details of model training 220 are described herein in other figures (e.g., FIG. 1, FIGS. 3 and 4, FIGS. 5 and 6, and FIGS. 7-12). In some aspects, model training 220 uses low-rank adaptation 218 (LoRA) which uses a small number of training parameters to fine tune an image generation model, as described in detail in FIG. 4. It should be noted that the model training 220 uses both the generic image generation model 210 and the brand-aligned image generation model 222 during training (e.g., tuning them both) so that the resultant brand-aligned image generation model can generate both brand-aligned and non-brand-aligned content.

FIG. 3 is a block diagram 300 illustrating loss functions of the brand-aligned image generation system 104, in accordance with some implementations of the present disclosure. As illustrated in FIG. 3, the set of model images 302 used to train image model 306 may include millions of images, while the set of brand-aligned images 304 may include only tens of images (e.g., less than a hundred images). Even accounting for a plurality of negative images for each of the brand-aligned images 304, the set of model images 302 is significantly larger than the set of brand-aligned images 304. Using a standard loss function 308 in image model 306 can lead to model collapse 310. As used herein, model collapse 310 is where a machine learning model gradually degrades due to errors that come from uncurated training based on the outputs of another model (including prior versions of itself). Such outputs are known as synthetic data. Model collapse generally occurs due to approximation errors, sampling errors, and learning errors.

Conversely, training the brand-aligned learning model 318 with the model images 312, the brand-aligned images 314, and a set of non-brand-aligned images 316 generates a brand-aware loss function 320 that has no model collapse 322. The model images 312 and the brand-aligned images 314 are as described above. The set of non-brand-aligned images 316 comprises a set of images, typically selected from the model images 312 that are not related to the brand identity in any way. This set of non-brand-aligned images 316 may include hundreds of images that can be manually or automatically selected and that help preserve the ability of the brand-aligned learning model to generate non-brand-aligned content and thus have no model collapse 322.

The brand-aware loss function 320 is generated as follows. The brand-aware loss function, denoted L_{brand-dpo} is:

$${L}_{brand - dpo} = {L}_{dpo} + λ {L}_{know} \qquad ( 1 )$$

where L_{dpo} is the standard diffusion-DPO loss on the pairwise data, λ is a hyperparameter (e.g., a value that can be chosen and/or adjusted during training that can increase or decrease the effect of the knowledge preservation term L_{know}), and L_{know} is a noise reconstruction term that prevents model collapse:

$${L}_{know} = {\vert {ϵ}_{θ} ( {x}_{t} ) - {ϵ}_{ref} ( {x}_{t} ) \vert}_{2} \qquad ( 2 )$$

Here, L_{know} is a noise reconstruction loss that causes the diffusion network ϵ_{θ}(xₜ) to retain the noise latent knowledge from the base model ϵ_{ref} (xₜ), where xₜ is sampled from non-brand-aligned images 316. This brand-aware loss function minimizes the differences between the images generated by the base model (e.g., the image model 306) and the images generated by the fine-tuned model (e.g., the brand-aligned image model 318).

Using this brand-aware loss function 320 helps the fine-tuned model (e.g., the brand-aligned image model 318) generate the same non-brand-aligned images that the image model 306 would generate while also generating brand-aligned images when needed. In simple terms, this helps the fine-tuned model learn the brand identity while preventing it from forgetting the non-brand concepts that were trained from the model images 312.

FIG. 4 is a block diagram 400 illustrating low-rank adaptation (LoRA) modules to train the brand-aligned image generation model of the brand-aligned image generation system 104, in accordance with some implementations of the present disclosure. Model training 402 uses low-rank adaptation modules 408 at layer 1 404 to provide parameter sets Aₗ and Bₗ. Here, parameter sets Aₗ and Blare constructed so that the product of Aₗ and Bₗ is a matrix that is of the same rank as the layer weights 406 (e.g., the same rank as layer weight matrix Wₗ). This allows generation of network parameter 410, which is: Wₗ+(Aₗ×Bₗ). So, for example, if Wₗ is a 10×10 matrix (e.g., with 100 parameters0, then Aₗ and Bₗ can be 10×1 and 1×10 matrices respectively (e.g., ten parameters each) that, when multiplied, yield a 10×10 matrix. LoRA is a commonly used technique when training a relatively few number of parameters of the base model.

However, as described herein, using LoRA in this way enables the loss formulation to maintain and train both models (e.g., the base model and the brand-aware model) so that the resulting brand-aware image generation model can generate both brand-aware and non-brand-aware images. LoRA also allows efficient on-loading and off-loading of the parameters, which enables more efficient use of computational resources when training the brand-aware image generation model.

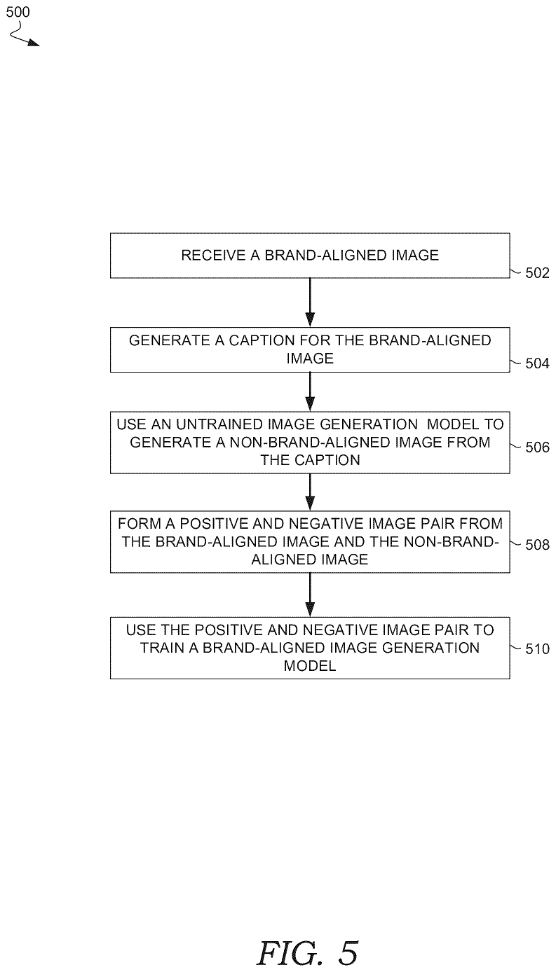

FIG. 5 is a flow diagram 500 showing an example process for training the brand-aligned image generation model of the brand-aligned image generation system 104, in accordance with some implementations of the present disclosure. The process (or method) illustrated in FIG. 5 is performed by, for instance, the brand-aligned image generation system 104 described herein at least in connection with FIG. 1. Each block of the process (or method) illustrated in FIG. 5 and any other processor or methods described herein can comprise a computing process performed using any combination of hardware, firmware, and/or software. For instance, various functions are carried out by a processor executing instructions stored in memory. The processes or methods can also be embodied as computer-usable instructions stored on computer storage media. The processes or methods can be provided by a standalone application, a service or hosted service (standalone or in combination with another hosted service), a plug-in to another product, or other such applications, services, products, or plug-ins.

At block 502, a processing device implementing aspects of the present disclosure performs operations to receive a brand-aligned image. It should be understood that, while the example process for training the brand-aligned image generation model of the brand-aligned image generation system 104 illustrated in FIG. 5 is described in terms of a single brand-aligned image, the brand-aligned image received at block 502 may be one of a plurality of brand-aligned images. In some aspects, after block 502, the process illustrated in FIG. 5 continues at block 504.

At block 504, a processing device implementing aspects of the present disclosure performs operations to generate a caption of the brand-aligned image received at block 502. In some aspects, at block 504, a simple caption is generated, as described above. In some aspects, at block 504, a dense caption is generated. In some aspects, both a simple caption and a dense caption are generated. In some aspects, at block 504, both a simple and a dense caption are generated. In some aspects, after block 504 the process illustrated in FIG. 5 continues at block 506.

At block 506, a processing device implementing aspects of the present disclosure performs operations to generate images from the caption or captions generated at block 504, using an untrained (e.g., not fine-tuned) image generation model. In some aspects, a plurality of images are generated for each of the captions so that, for example, if there are two captions generated at block 504 (e.g., a simple and a dense caption), at block 506, several images can be generated for each of the captions. For example, as described above, for one brand-aligned image (e.g., received at block 502) with two captions (e.g., generated at block 504), five images can be generated for each caption, resulting in ten generated images. As described above, the images generated at block 506 comprise the set of negative images used in block 508. In some aspects, after block 506, the process illustrated in FIG. 5 continues at block 508.

At block 508, a processing device implementing aspects of the present disclosure performs operations to form a positive and negative image pair from the brand-aligned image received at block 502 and each of the images generated at block 506 so that, in the example described above, with ten generated images, ten positive and negative image pairs (each comprising the brand-aligned images and one of the images generated at block 506) are generated. In some aspects, after block 508, the process illustrated in FIG. 5 continues at block 510.

At block 510, a processing device implementing aspects of the present disclosure performs operations to use the positive and negative image pairs generated at block 508 to train the brand-aligned image generation model of the brand-aligned image generation system 104. In some aspects, after block 510, the process illustrated in FIG. 5 terminates. In some aspects, not shown in FIG. 5, after block 510, the process illustrated in FIG. 5 continues at block 502 to receive another brand-aligned image or to receive another set of brand-aligned images.

Although not illustrated in FIG. 5, in some configurations, the operations of the process illustrated in FIG. 5 are performed in a different order than that described. In some configurations, where operations are performed in a different order, some of the operations are performed in parallel by a plurality of devices such as those described herein, using a plurality of threads. As may be contemplated, other orders in which to perform the operations illustrated in flow diagram 500 may be considered as being within the scope of the present disclosure.

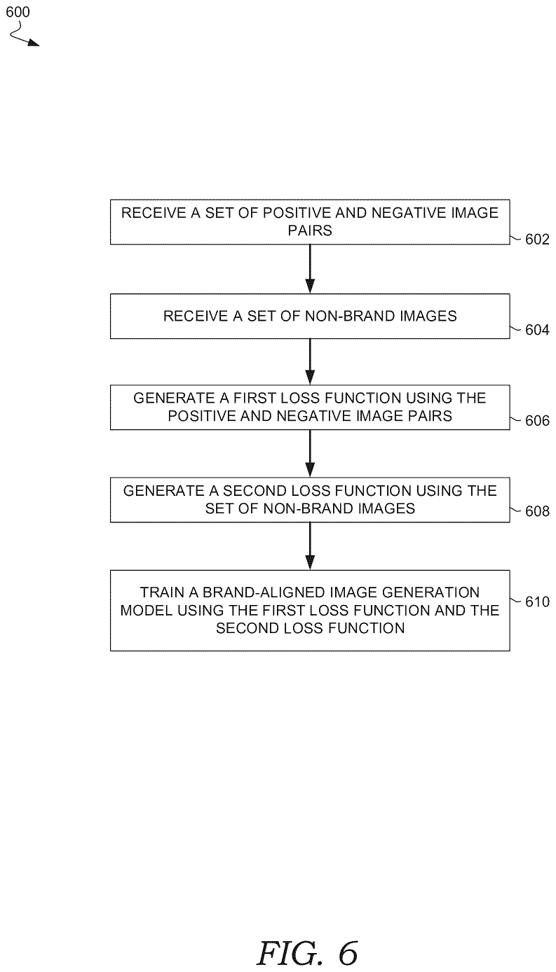

FIG. 6 is a flow diagram 600 showing an example process for training the brand-aligned image generation model of the brand-aligned image generation system 104, in accordance with some implementations of the present disclosure. The process (or method) illustrated in FIG. 6 is performed by, for instance, the brand-aligned image generation system 104 described herein at least in connection with FIG. 1. Each block of the process (or method) illustrated in FIG. 6 and any other processor or methods described herein can comprise a computing process performed using any combination of hardware, firmware, and/or software. For instance, various functions are carried out by a processor executing instructions stored in memory. The processes or methods can also be embodied as computer-usable instructions stored on computer storage media. The processes or methods can be provided by a standalone application, a service or hosted service (standalone or in combination with another hosted service), a plug-in to another product, or other such applications, services, products, or plug-ins.

At block 602, a processing device implementing aspects of the present disclosure performs operations to receive a set of positive and negative image pairs such as those generated at block 508 of the process illustrated in FIG. 5. In some aspects, after block 602, the process illustrated in FIG. 6 continues at block 604.

At block 604, a processing device implementing aspects of the present disclosure performs operations to receive a set of non-brand images. In some aspects, the set of non-brand images received at step 604 are images selected from images used to train a generic or base model, as described above. In some aspects, the set of non-brand images received at step 604 are automatically selected. In some aspects, the set of non-brand images received at step 604 are manually selected. In some aspects, after block 604 the process illustrated in FIG. 6 continues at block 606.

At block 606, a processing device implementing aspects of the present disclosure performs operations to generate a first loss function using the positive and negative image pairs received at block 602 (e.g., using a diffusion-DPO term L_{dpo}, described above in equation (1)). In some aspects, after block 606, the process illustrated in FIG. 6 continues at block 608.

At block 608, a processing device implementing aspects of the present disclosure performs operations to generate a second loss function using the set of non-brand images received at block 604 (e.g., using a noise reconstruction term that prevents model collapse L_{know} as described above in equation (2)). In some aspects, after block 608, the process illustrated in FIG. 6 continues at block 610.

At block 610, a processing device implementing aspects of the present disclosure performs operations to train a brand-aligned image generation model using the first loss function (e.g., generated at block 606) and the second loss function (e.g., generated at block 608), as described herein. In some aspects, after block 610, the process illustrated in FIG. 6 terminates. In some aspects, not shown in FIG. 6, after block 610, the process illustrated in FIG. 6 continues at block 602 to receive another set of positive and negative image pairs.

Although not illustrated in FIG. 6, in some configurations, the operations of the process illustrated in FIG. 6 are performed in a different order than that described. In some configurations, where operations are performed in a different order, some of the operations are performed in parallel by a plurality of devices such as those described herein, using a plurality of threads. As may be contemplated, other orders in which to perform the operations illustrated in flow diagram 600 may be considered as being within the scope of the present disclosure.

### Architecture: Pixel Diffusion

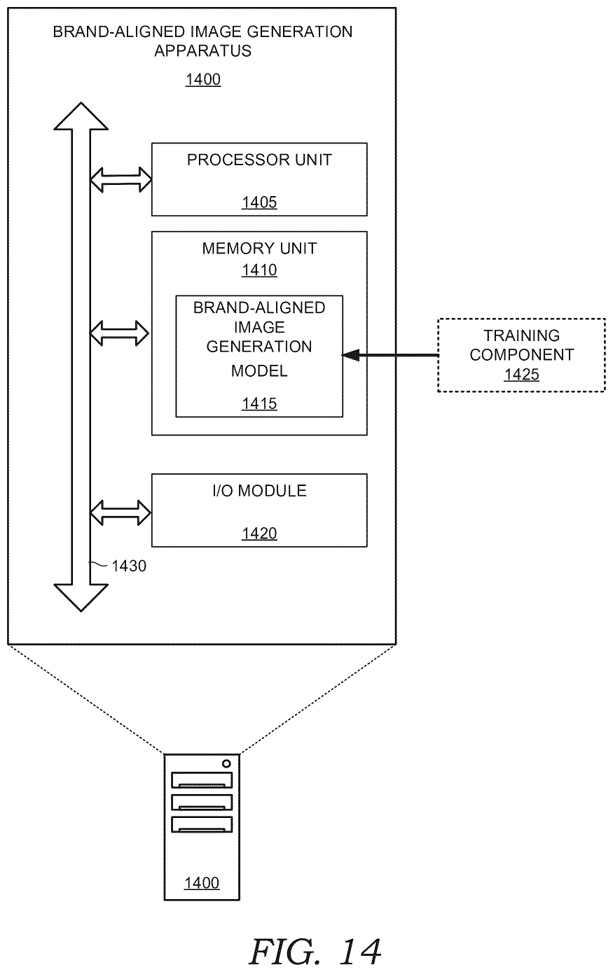

FIG. 7 shows an example of a guided diffusion model 700 according to aspects of the present disclosure. In some examples, guided diffusion model 700 describes the operation and architecture of the brand-aligned image generation model 1415 described with reference to FIG. 14. The guided diffusion model 700 depicted in FIG. 7 is an example of, or includes aspects of, a media generation model as described herein. In some aspects, the guided image diffusion model 700 depicted in FIG. 7 is a guided latent diffusion model.

Diffusion models are a class of generative neural networks that can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 740 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Model (DDIM). In DDPM, the generative process includes reversing a stochastic Markov diffusion process. DDIMs, on the other hand, use a deterministic process so that the same input results in the same output. In some cases, DDIMs can reduce the number of time steps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. ARCHITECTURE: U-NET

FIG. 8 shows an example of a U-Net 800 according to aspects of the present disclosure. In some examples, U-Net 800 is an example of the component that performs the reverse diffusion process 725 of guided diffusion model 700 described with reference to FIG. 7 and includes architectural elements of the brand-aligned image generation model 1415 described with reference to FIG. 14. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels, and processes the input features 805 using an initial neural network layer 810 (e.g., a convolutional network layer) to produce intermediate features 815. The intermediate features 815 are then down-sampled using a down-sampling layer 820 such that down-sampled features 825 have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

### Inference: Conditional Generation

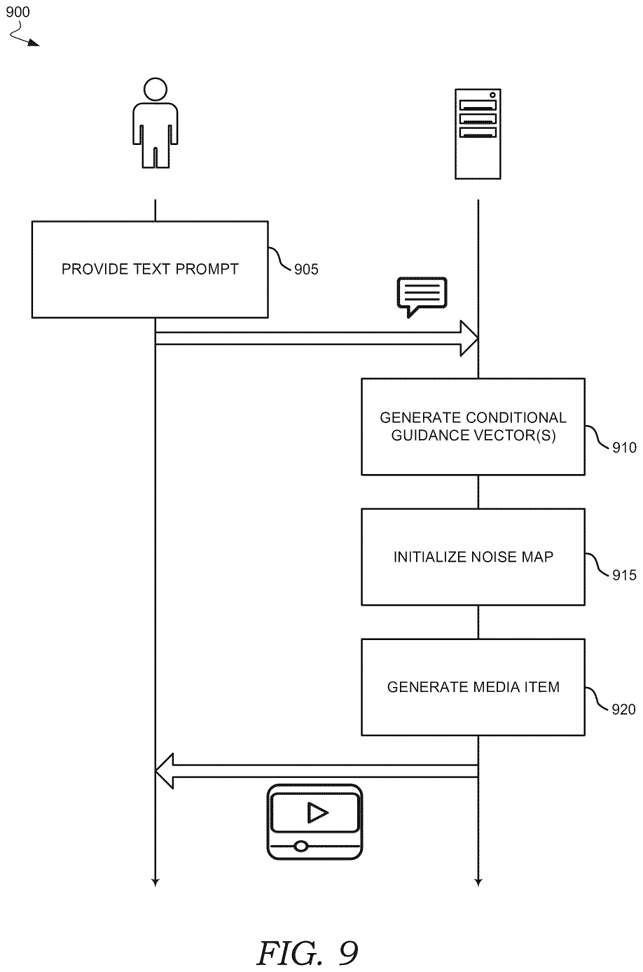

FIG. 9 shows an example of a method 900 for conditional media generation according to aspects of the present disclosure. In some examples, method 900 describes an operation of the brand-aligned image generation model 1415 described with reference to FIG. 14 such as an application of the guided diffusion model 700 described with reference to FIG. 7. In some examples, these operations are performed by a system including a processor executing a set of codes to control functional elements of an apparatus such as the media generation model described in FIG. 7.

Additionally or alternatively, steps of the method 900 may be performed using special-purpose hardware. Generally, these operations are performed according to the methods and processes described in accordance with aspects of the present disclosure. In some cases, the operations described herein are composed of various sub-steps, or are performed in conjunction with other operations.

At operation 905, a user provides a text prompt describing content to be included in a generated media item. For example, a user may provide the prompt “a person playing with a cat”. In some examples, guidance can be provided in a form other than text, such as via an image, a sketch, or a layout.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 915, a noise map is initialized that includes random noise. The noise map may be in a pixel space or a latent space. By initializing a media item with random noise, different variations of a media item including the content described by the conditional guidance can be generated.

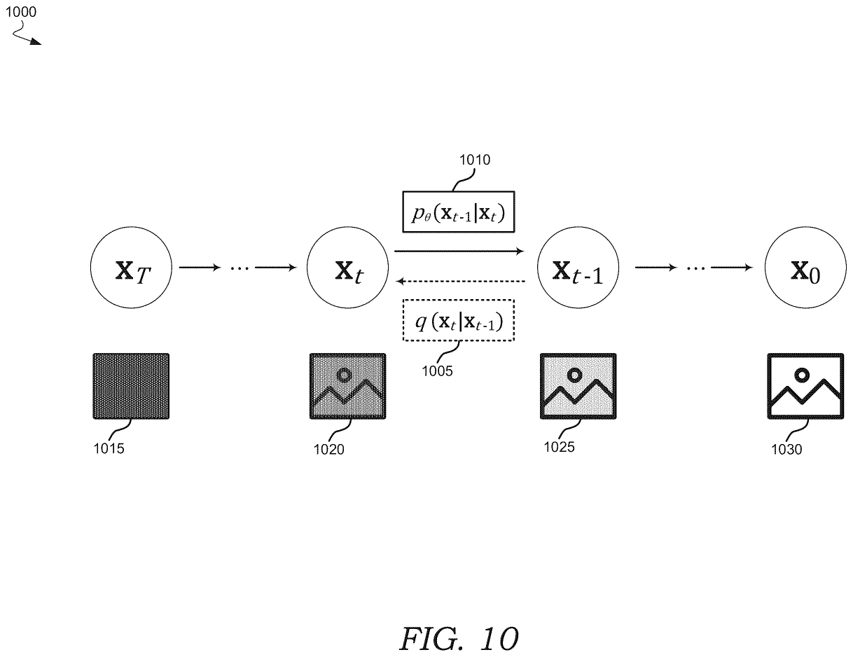

At operation 920, the system generates a media item based on the noise map and the conditional guidance vector. For example, the media item may be generated using a reverse diffusion process as described with reference to FIG. 10.

### Inference: Reverse Diffusion

FIG. 10 shows a diffusion process 1000 according to aspects of the present disclosure. In some examples, diffusion process 1000 describes an operation of the brand-aligned image generation model 1415 described with reference to FIG. 14, such as the reverse diffusion process 725 of guided diffusion model 700 described with reference to FIG. 7.

As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) and intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015, and denoises the data to obtain the p(xₜ₋₁|xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x_{T} reverts back to x₀, the original media item 1030. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 4 )$$

where P(x_{T})=N(x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of additions of Gaussian noise to the sample.

At interference time, observed data x₀ in a pixel space can be mapped into a latent space as input, and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

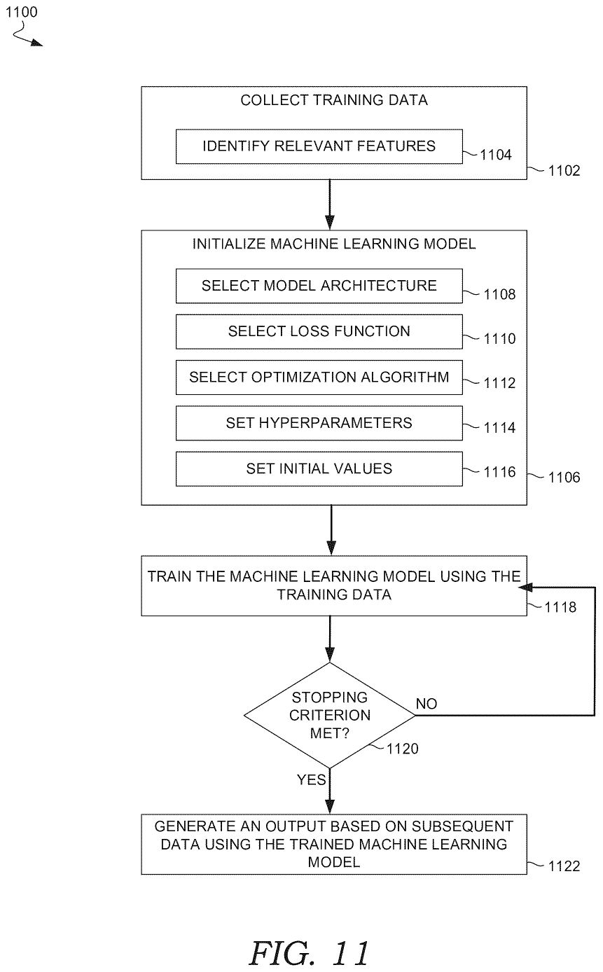

FIG. 11 is a flow diagram depicting an algorithm as a step-by-step procedure 1100 in an example implementation of operations performable for training a machine learning model. In some embodiments, the procedure 1100 describes an operation of the training component 1425 described for configuring the brand-aligned image generation model 1415 as described with reference to FIG. 14. The procedure 1100 provides one or more examples of generating training data, use of the training data to train a machine learning model, and use of the trained machine learning model to perform a task.

To begin in this example, a machine learning system collects training data (block 1102) that is to be used as a basis to train a machine learning model, (i.e., which defines what is being modeled). The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1104) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1106). Initialization of the machine learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine learning model (i.e., predictions) and target values (e.g., as expressed by the training data) to be used to train the machine learning model. Additionally, an optimization algorithm is selected (1112) that is to be used in conjunction with the loss function to optimize parameters of the machine learning model during training, examples of which include gradient descent, stochastic gradient descent (SGD), and so forth.

Initialization of the machine learning model further includes setting hyperparameters (block 1114) and initial values (block 1116) of the machine learning model, examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1118) by the machine learning system. A machine learning model refers to a computer representation that can be tuned (e.g., trained and retrained) based on inputs of the training data to approximate unknown functions. In particular, the term “machine learning model” can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1120), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues the training of the machine learning model using the training data (block 1118) in this example.

If the stopping criterion is met (“yes” from decision block 1120), the trained machine learning model is then utilized to generate an output based on subsequent data (block 1122). The trained machine learning model, for instance, is trained to perform a task as described above, and therefore once trained is configured to perform that task based on subsequent data received as an input and processed by the machine learning model.

### Training: Diffusion Training

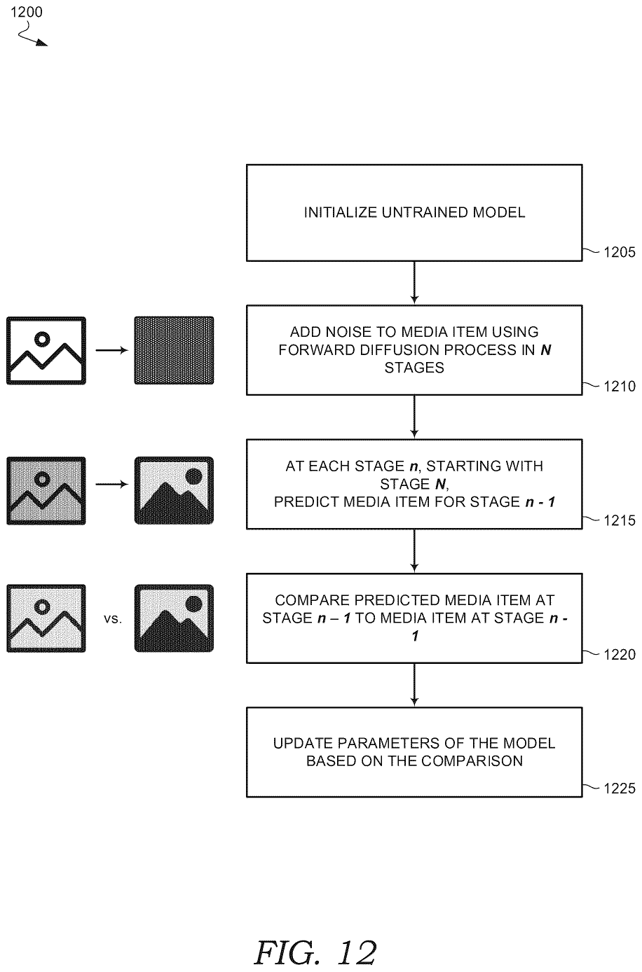

FIG. 12 shows an example of a method 1200 for training a diffusion model according to aspects of the present disclosure. In some embodiments, the method 1200 describes an operation of the training component 1425 described for configuring the brand-aligned image generation model 1415 as described with reference to FIG. 14. The method 1200 represents an example for training a reverse diffusion process, as described above with reference to FIG. 10. In some examples, these operations are performed by a system including a processor executing a set of codes to control functional elements of an apparatus, such as the guided diffusion model described in FIG. 7.

Additionally or alternatively, certain processes of method 1200 may be performed using special-purpose hardware. Generally, these operations are performed according to the methods and processes described in accordance with aspects of the present disclosure. In some cases, the operations described herein are composed of various sub-steps, or are performed in conjunction with other operations.

At operation 1205, the user initializes an untrained model. Initialization can include defining the architecture of the model and establishing initial values for the model parameters. In some cases, the initialization can include defining hyperparameters such as the number of layers, the resolution and channels of each layer blocks, the location of skip connections, and the like.

At operation 1210, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1215, the system at each stage n, starting with stage N, performs a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

### System: Computing Device

FIG. 13 shows an example of a computing device 1300 according to aspects of the present disclosure. The computing device 1300 may be an example of the brand-aligned image generation apparatus 1400 described with reference to FIG. 14. In one aspect, computing device 1300 includes processor(s) 1305, memory subsystem 1310, communication interface 1315, input/output (I/O) interface 1320, user interface component(s) 1325, and channel 1330.

In some embodiments, computing device 1300 is an example of, or includes aspects of, the media generation model of FIG. 7. In some embodiments, computing device 1300 includes one or more processors 1305 that can execute instructions stored in memory subsystem 1310 to perform media generation.

According to some aspects, computing device 1300 includes one or more processors 1305. In some cases, a processor is an intelligent hardware device, comprising, for example, a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS@, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

### System: Brand-Aligned Image Generation Apparatus

FIG. 14 shows an example of a brand-aligned image generation apparatus 1400 according to aspects of the present disclosure. Brand-aligned image generation apparatus 1400 may include an example of, or aspects of, the guided diffusion model described with reference to FIG. 7 and the U-Net described with reference to FIG. 8. In some embodiments, brand-aligned image generation apparatus 1400 includes processor unit 1405, memory unit 1410, brand-aligned image generation model 1415, I/O module 1420, training component 1425, and channel 1430 (e.g., a channel such as channel 1330, described in connection with FIG. 13). Training component 1425 updates parameters of the brand-aligned image generation model 1415 stored in memory unit 1410. In some examples, the training component 1425 is located outside the brand-aligned image generation apparatus 1400.

Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors described with reference to FIG. 13.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory subsystem 1310 described with reference to FIG. 13.

According to some aspects, brand-aligned image generation apparatus 1400 uses one or more processors of processor unit 1405 to execute instructions stored in memory unit 1410 to perform functions described herein. For example, the brand-aligned image generation apparatus 1400 can perform operations to generate brand-aligned images using the brand-aligned image generation model 1415 that is trained using systems and methods described herein.

The memory unit 1410 may include a brand-aligned image generation model 1415 trained to generate brand-aligned images using the training methods described herein (e.g., at least in connection with FIGS. 5 and 6). For example, after training, the brand-aligned image generation model 1415 may perform inferencing operations as described with reference to FIGS. 9 and 10 to generate brand-aligned images.

In some embodiments, the brand-aligned image generation model 1415 is an artificial neural network (ANN) such as the guided diffusion model described with reference to FIG. 7 and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of brand-aligned image generation model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train the brand-aligned image generation model 1415. For example, parameters of the brand-aligned image generation model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 11 and 12). The goal of the training process may be to find optimal values for the parameters that allow the machine learning model to make accurate predictions or perform well on the given task.

Accordingly, the node weights can be adjusted to improve the accuracy of the output (i.e., by minimizing a loss that corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the brand-aligned image generation model 1415 can be used to make predictions on new, unseen data (i.e., during inference).

I/O module 1420 receives inputs from and transmits outputs of the brand-aligned image generation apparatus 1400 to other devices or users. For example, I/O module 1420 receives inputs for the brand-aligned image generation model 1415 and transmits outputs of the brand-aligned image generation model 1415. According to some aspects, I/O module 1420 is an example of the I/O interface 1320 described with reference to FIG. 13.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. A computer system comprising:
one or more processors; and
one or more computer storage media storing computer-useable instructions that, when used by the one or more processors, causes the computer system to perform operations comprising:
receiving a brand-aligned image;
generating a caption describing the brand-aligned image, using a caption generation component;
generating a non-brand-aligned image based, at least in part, on the caption, using a generic image generation model of a generic image generation component;
forming an image pair comprising the brand-aligned image and the non-brand-aligned image, using an image dataset component; and
training a brand-aligned image generation model based, at least in part, on the image pair, using an image generation model training component.

2. The computer system of claim 1, wherein the caption generated is a simple caption.

3. The computer system of claim 1, wherein the caption generated is a dense component comprising brand identity information obtained from a brand concept document.

4. The computer system of claim 1, the operations further comprising:
receiving a prompt, at the trained brand-aligned image generation model, to generate a new brand-aligned image;
using the brand-aligned image generation model to generate the new brand-aligned image; and
presenting the new brand-aligned image, using a user interface.

5. The computer system of claim 1, wherein the brand-aligned image generation model is trained using a diffusion-DPO loss term that is based, at least in part, on the image pair.

6. The computer system of claim 1, wherein the brand-aligned image generation model is trained using a noise reconstruction term that prevents model collapse that is based, at least in part, on one or more additional non-brand images.

7. The computer system of claim 1, wherein the brand-aligned image generation model is trained using a low-rank adaptation (LoRA) module that simultaneously stores the generic image generation model and the brand-aligned image generation model in memory of the computer system.

8. A computer-implemented method comprising:
receiving, via a loss-function component, a set of image pairs, each comprising a positive image and a negative image;
receiving, via the loss-function component, a set of non-brand images;
generating, via the loss-function component, a first loss function based, at least in part, on the set of image pairs;
generating, via the loss-function component, a second loss function based, at least in part, on the set of non-brand images; and
training, via an image generation model training component, a brand-aligned image generation model using the first loss function and the second loss function.

9. The computer-implemented method of claim 8, wherein the positive image is a brand-aligned image.

10. The computer-implemented method of claim 9, wherein the negative image is an image generated by a generic image generation component based, at least in part, on a caption of the brand-aligned image, generated by a language model.

11. The computer-implemented method of claim 10, wherein the caption is a simple caption.

12. The computer-implemented method of claim 10, wherein the caption is a dense caption based, at least in part, on brand identity information obtained from a brand concept document.

13. The computer-implemented method of claim 8, further comprising:
receiving, via a caption generation component, a prompt to generate a new brand-aligned image;
generating the new brand-aligned image using the trained brand-aligned image generation model based, at least in part, on the prompt; and
presenting the new brand-aligned image, using a user interface.

14. The computer-implemented method of claim 8, wherein the brand-aligned image generation model is trained using a low-rank adaptation (LoRA) module that performs on-loading and off-loading operations of parameters of the first loss function and the second loss function.

15. One or more computer storage media storing computer-useable instructions that, when used by one or more computing devices, cause the one or more computing devices to perform operations, the operations comprising:
receiving a prompt, at a brand-aligned image generation model, to generate a brand-aligned image, the brand-aligned image generation model trained based, at least in part, on a set of image pairs, each comprising a positive image and a negative image, and a set of non-brand images;
generating a brand-aligned image using the brand-aligned image generation model; and
presenting the brand-aligned image, using a user interface.

16. The one or more computer storage media of claim 15, wherein the brand-aligned image generation model is trained using a diffusion-DPO loss term that is based, at least in part, on the set of image pairs.

17. The one or more computer storage media of claim 15, wherein the brand-aligned image generation model is trained using a noise reconstruction term that prevents model collapse that is based, at least in part, on the set of non-brand images.

18. The one or more computer storage media of claim 15, wherein each image pair of the set of image pairs comprises a first image and a second image that is generated by:
generating a caption describing the first image; and
generating the second image based, at least in part, on the caption, using a generic image generation model.

19. The one or more computer storage media of claim 18, wherein the first image is a brand-aligned image.

20. The one or more computer storage media of claim 18, wherein the brand-aligned image generation model is trained using a low-rank adaptation (LoRA) module that simultaneously stores the generic image generation model and the brand-aligned image generation model in memory of the one or more computing devices.
